(19) United States
(12) Patent Application Publication
(10) Pub. No.: US 2025/0173646 A1
(43) Pub. Date: May 29, 2025

(54) Automated Impact Assessment for Unallocated Shifts

(71) Applicant: ZEBRA TECHNOLOGIES CORPORATION, Lincolnshire, IL (US)

(72) Inventors: Niwedita Dubey, Raleigh, NC (US); Hareesh Babu Annu, Mansfield, MA (US)

(21) Appl. No.: 18/519,607

(22) Filed: Nov. 27, 2023

(51) Int. Cl. G06Q 10/0631; G06Q 10/0639

(52) U.S. Cl. CPC G06Q 10/063116; G06Q 10/0639

(57) ABSTRACT

A method includes: detecting, at a computing device, an unallocated shift record corresponding to a facility, the unallocated shift record defining a time period and a task identifier; executing, at the computing device, a classification model to generate an index corresponding to the unallocated shift record; generating, at the computing device, an impact indicator for the unallocated shift record based on the time period, the task identifier, and the index; selecting a control action for the unallocated shift record according to the impact indicator; and executing the selected control action.

### BACKGROUND

The generation of scheduling data, such as a set of shifts for distribution to employees in a retail facility or the like, can be a complex multi-variate process, as can the filling of open shifts left vacant by staff absences or the like. Filling open shifts can therefore be a time-consuming and error-prone process, and may be associated with inefficient use of labor and/or computational resources.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for automatically generating impact indicators for open shifts.

FIG. 2 is a flowchart of a method of automatically generating impact indicators for open shifts.

FIG. 3 is a diagram illustrating the receipt of an allocation request at block 205 of the method of FIG. 2.

FIG. 4 is a diagram illustrating an example performance of blocks 210 and 215 of the method of FIG. 2.

FIG. 5 is a diagram illustrating an example performance of blocks 225 and 230 of the method of FIG. 2.

FIG. 6 is a flowchart illustrating an example performance of block 235 of the method of FIG. 2.

FIG. 7 is a diagram illustrating an example performance of block 605 of the method of FIG. 6.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method including: detecting, at a computing device, an unallocated shift record corresponding to a facility, the unallocated shift record defining a time period and a task identifier; executing, at the computing device, a classification model to generate an index corresponding to the unallocated shift record; generating, at the computing device, an impact indicator for the unallocated shift record based on the time period, the task identifier, and the index; selecting a control action for the unallocated shift record according to the impact indicator; and executing the selected control action.

Additional examples disclosed herein are directed to a computing device, comprising: a memory; and a processor configured to: detect an unallocated shift record corresponding to a facility, the unallocated shift record defining a time period and a task identifier; execute a classification model to generate an index corresponding to the unallocated shift record; generate an impact indicator for the unallocated shift record based on the time period, the task identifier, and the index; select a control action for the unallocated shift record according to the impact indicator; and execute the selected control action.

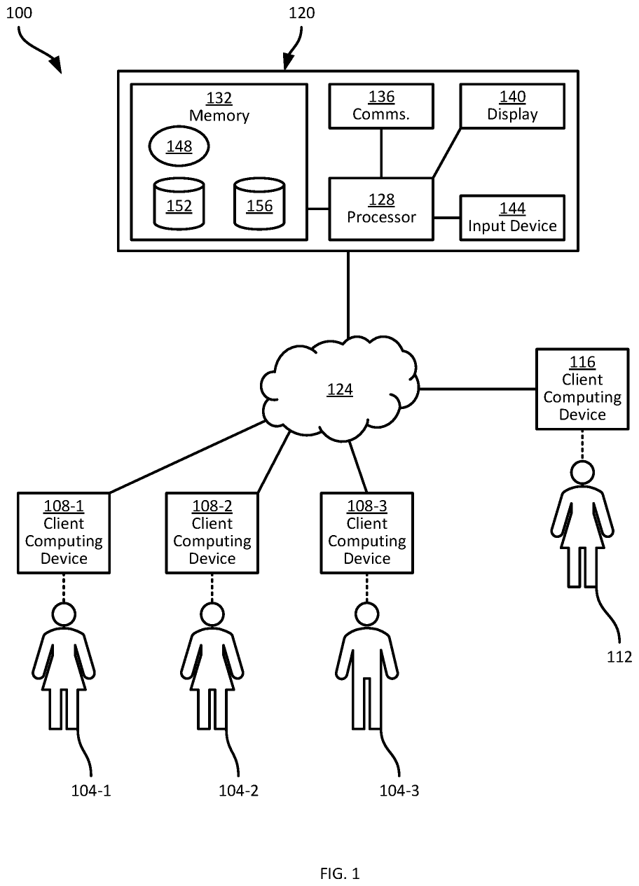

FIG. 1 illustrates a system 100 for automatically assessing the impact of unallocated shifts in a schedule, based at least in part on machine-inferred variables. The system 100 can be deployed in association with one or more retail facilities, manufacturing facilities, healthcare facilities, or the like, to deploy scheduling data to a plurality of employees in the facility. Three example employees 104-1, 104-2, and 104-3 are shown in FIG. 1, although it will be understood that the system 100 can deploy scheduling data to a greater number of employees than those shown. The employees 104-1, 104-2, and 104-3 may also be referred to below collectively as the employees 104, and any given employee may be referred to generically as an employee 104. Similar nomenclature is used elsewhere herein for reference numbers with hyphenated suffixes.

Deploying scheduling data to the employees 104 includes providing at least some of the employees 104 (e.g., as few as one of the employees 104, and as many as all of the employees 104) with data defining which periods of time those employees are scheduled to work at the facility. Each such period is referred to as a shift. The data defining a given shift can also define a wide variety of other information, including which task(s) are assigned to an employee during the shift, which locations an employee 104 is assigned to for a given shift, for example if the system 100 manages scheduling for more than one physical facility, and the like.

The complexity of generating scheduling data can increase with the number of employees 104, the size of the facility (e.g., greater labor demands at larger facilities may involve assigning concurrent shifts to larger numbers of employees), the variety of tasks to be performed, and the like. Various systems therefore implement automated schedule generation mechanisms. Such systems consume a variety of inputs corresponding to the employees 104, such as employee type (e.g., full-time or part-time), employee skills and/or certifications, planned employee absences, and the like. Such systems also consume inputs associated with the facility, such as definitions of labor demand over a planning period. For example, the labor demand can be defined as a number of hours for each of a plurality of tasks to be performed in the facility, for each day (or other suitable period) over a planning period, such as one week. By processing those inputs, automated schedule generation systems seek to generate a set of shifts assigned to at least a portion of the employees 104 over the planning period, optimized according to a variety of factors. Examples of those factors include fulfilling the defined labor demand, reducing or avoiding unassigned time during shifts (e.g., time during which no task is assigned to an employee), and avoiding conflicts with labor laws and scheduling rules (e.g., maximum permitted consecutive working hours, minimum break lengths between shifts, and the like).

A schedule generated by such an automated generation system can be deployed to the employees 104 by, for example, transmitting shift definitions to the employees 104 to whom those shifts are assigned. For example, each employee 104 can operate a respective client computing device 108-1, 108-2, 108-3, such as a smartphone, a tablet computer, or the like. Shifts can be transmitted to the client devices 108 for viewing by the relevant employees via a web browser, a dedicated scheduling application, or the like. The automatically generated schedule can also be provided to an administrator 112, such as a manager of the facility (the facility may have more than one manager in some examples), via a client computing device 116 operated by the administrator 112. The administrator 112 and the employees 104 may, for example, have account credentials or the like permitting access to a web-based application where schedule data can be viewed and/or edited.

The provision of a schedule to either or both of the employees 104 and the administrator 112 via the client devices 108 and 116 is generally followed by implementation of the schedule by the employees 104 and/or the administrator 112. For example, each employee 104 can attend at the location defined in a given shift record (e.g., a collection of data defining various attributes of the shift), at the time defined in that shift record, to perform the task(s) identified in that shift record.

Under certain conditions, however, implementing a shift in a schedule is impeded or prevented because no employee 104 is assigned to the shift. A shift that lacks an allocated employee 104 may be referred to as an open shift. Open shifts can arise from employees 104 being unable to attend due to illness or a wide variety of other circumstances. In some cases, the originally generated schedule may lack an employee allocation for a shift, e.g., due to a constrained labor supply, operator error on the part of the administrator 112, or the like.

Filling an open shift, e.g., by allocating an employee 104 to the open shift, can be accomplished in a variety of ways. For example, the administrator 112 can view the schedule, e.g., on the device 116, and, upon observing an open shift, the administrator 112 can initiate a process to advertise the open shift to eligible employees 104 without conflicting shifts. Eligible employees include those with roles and/or skills, certifications and the like that are compatible with the tasks and/or other attributes of the open shift. Advertising the open shift to eligible employees 104 can include transmitting notifications to the relevant client devices 108. The notifications can also be associated with incentives (e.g., monetary incentives, rewards points, or the like) for accepting an open shift. The administrator 112 may also elect, in response to observing an open shift, to re-assign an eligible employee 104 from another shift to the open shift (thereby creating a further open shift, which also be handled as set out above).

Certain systems may also be configured to perform the above actions (e.g., advertising open shifts with or without incentives, re-assigning open shifts, and the like) automatically. However, previous attempts, whether by automated systems or administrators 112, to fill open shifts can result in an inefficient deployment of employees 104, and can lead to the avoidable creation of further open shifts, suboptimal deployment of incentives, and the like. The above inefficiencies can result at least in part from the varying impacts between open shifts. One open shift, for example, may have a greater impact on the facility if filled (or corresponding negative impact if left unfilled) than another open shift. For example, the shift with the greater impact may coincide with an opening or closing time period for the facility, a time period with few or no other employees 104 on duty, or the like.

Filling the lower-impact shift instead of the higher-impact shift may therefore not be an optimal outcome. However, existing systems may be unable to assess the impact of an open shift. The administrator 112 may subjectively assess open shift impact, in the absence of automated assessment, but given the complexity of the system 100, such subjective judgements are sometimes inaccurate and therefore may lead to inefficient outcomes.

Existing systems may also, e.g., in addition to failing to assess the impact of open shifts or inaccurately making such assessments, inefficiently allocate incentives to open shifts. For example, certain open shifts may be sufficiently desirable to the pool of available employees 104 that filling such shifts is likely feasible with minimal or no incentives. Existing systems, however, may not be configured to assess the desirability of open shifts, and the subjective judgement of the administrator 112 may, as noted above, be inaccurate. When open shifts are advertised to the employees 104, incentives may be inefficiently deployed with such advertisements. Certain open shifts may, as a result, remain open, and/or the cost of filling certain open shifts may be greater than necessary.

The system 100, as described below, implements certain functionality to enable the automated assessment of factors that previous systems are unable to assess automatically. The system 100 permits, for example, structured assessment of open shift impacts, improving the accuracy with which open shifts are prioritized for incentives, assignments, re-assignments, and the like. The system 100 also permits the above structured assessment to be based in part on predicted shift desirability, to further improve the efficiency of incentive deployments, and the like.

The system 100 includes a computing device 120, such as a server, distributed computing device, or the like, in communication with the client devices 108 and 116 via a network 124 (e.g., a suitable combination of local and wide area networks). The device 120 is configured to infer the desirability, or popularity, of shift records (particularly, although not limited to, open shifts) from historical data corresponding to previous open shifts. The device 120 is also configured to generate, based in part on an index representing the desirability of an open shift, an impact indicator for the open shift. The above functionality permits the device 120 to automatically select and execute control actions, e.g., to advertise open shifts, assign and re-assign employees 104 to fill open shifts, and the like.

The device 120 includes a processor 128 (e.g., a central processing unit (CPU), graphics processing unit (GPU), and/or other suitable control circuitry, microcontroller, or the like), interconnected with a non-transitory computer readable storage medium, such as a memory 132. The memory 132 includes a suitable combination of volatile memory (e.g. Random Access Memory or RAM) and non-volatile memory (e.g. read only memory or ROM, Electrically Erasable Programmable Read Only Memory or EEPROM, flash memory). The memory 132 stores computer-readable instructions, execution of which by the processor 128 configures the processor 128 to perform various functions in conjunction with certain other components of the computing device 120. The computing device 120 also includes a communications interface 136 enabling the device 120 to exchange data with other computing devices such as the client devices 108 and 116, e.g., via the network 124. The device 120 can also include a display 140 and/or other suitable output device. The device 120 can further include an input device 144 such as a keyboard, a mouse, a touch panel or the like.

The instructions stored in the memory 132 include, in this example, a shift allocation application 148 that, when executed by the processor 128, configures the device 120 to detect and process open shifts. The functionality implemented by the application 148 can be integrated with a schedule generation application executed by the device 120, in some examples. The device 120 and the application 148 may be referred to in the discussion below as being configured to perform various actions. It will be understood that such references indicate that the device 120 is configured to perform those actions via execution of the application 148 by the processor 128. In some examples, the application 148 can be implemented via a suite of distinct applications, and/or via dedicated control hardware, such as an application-specific integrated circuit (ASIC) or the like.

The memory 132 can also store a repository 152, containing profile data corresponding to the employees 104 and/or the facility. The profile data can include labor laws, tasks performed at the facility and task priority indicators, and labor demand for the facility, which may be specified on a per-task basis and at various levels of granularity. For example, labor demand can be specified per task, at 15-minute intervals (although shorter or longer intervals can also be specified). The profile data in the repository 152 can also include employee profile data such as vacation and/or other absences, skills and certifications, full-time or part-time type indicators, and the like). The memory 132 can also store, in some examples, a repository 156 of schedule data, such as past and current shift records. The repository 156 can also contain, in some examples, indications of allocation requests for previous open shifts, as discussed below.

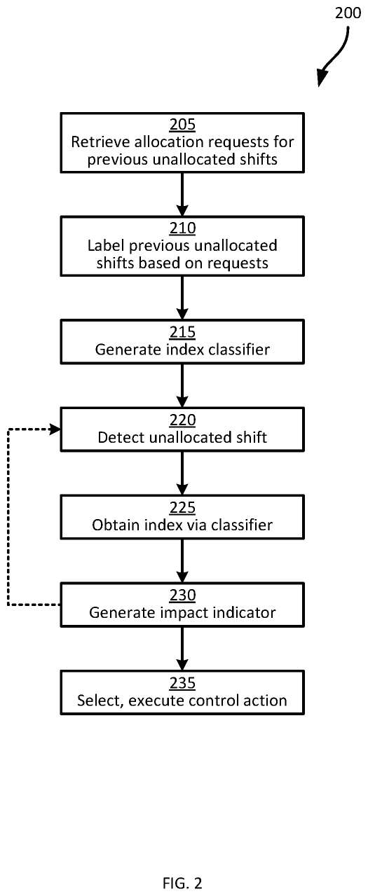

Turning to FIG. 2, a method 200 of automatically generating impact indicators for open shifts is illustrated. The method 200 is described below in conjunction with its performance by the device 120, via execution of the application 148 by the processor 128.

Performance of the method 200 can be divided into two phases. In a first phase, at blocks 205-215, the device 120 can be configured to collect data and generate a classification model, also referred to herein as a classifier, for generating desirability index values for open shifts. In the second phase, beginning at block 220, the device 120 can be configured to detect and process open shifts in a current schedule, relying at least in part on the classifier generated in the first phase. The classifier generated through the performance of blocks 205-215 can be periodically updated, e.g., by repeating the performance of blocks 205-215, but the second phase of the method 200 can also be performed a plurality of times without repeating blocks 205-215 (e.g., using the same classifier).

At block 205, the device 120 is configured to receive allocation requests for a plurality of previous open shifts (also referred to as unallocated shifts). An allocation request may also be referred to as a bid, and can be received at the device 120 from a client device 108 in response to an advertisement of a previous unallocated shift to one or more client devices. The allocation request indicates a request from the operator of the client device 108 (e.g., the corresponding employee 104) to accept the previous unallocated shift.

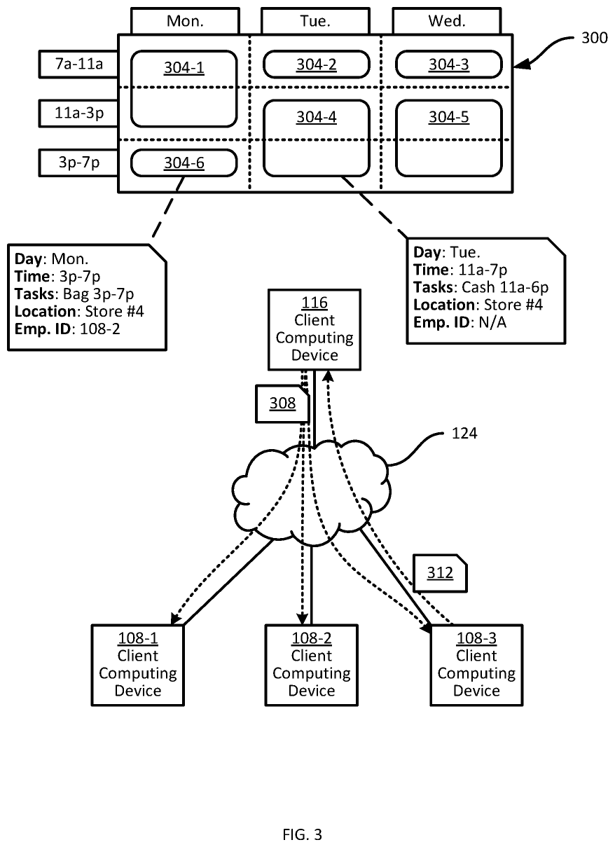

Turning to FIG. 3, an example schedule 300 is illustrated, e.g., as previously generated by the device 120. The schedule 300 divides each of three weekdays into three four-hour segments (e.g., 7 am to 11 am, 11 am to 3 pm, and 3 pm to 7 pm). The specific weekdays and segments shown are for illustrative purposes only, and it will be understood that a wide variety of other schedule structures can also be employed. The schedule 300 includes a plurality of shift records 304-1, 304-2, 304-3, 304-4, 304-5, and 304-6, each covering a portion of a corresponding weekday. For example, the shift record 304-1 extends from 7 am to 3 pm on Monday. The schedule 300 can include multiple shift records for the same time period in other examples. For example, more than one shift record 304 can exist for the time period covered by the shift record 304-1, e.g., if meeting labor demand at the facility involves having more than one employee on duty at that time.

Each shift record 304 can include a variety of attributes, such as a time period defined by shift start and end times, and one or more task identifiers corresponding to tasks assigned to the shift. The task identifiers can also be associated with time periods covering at least a portion of the shift record 304. Example contents of the shift records 304-4 and 304-6 are shown in FIG. 3, indicating that the shift record 304-4 has a total length of eight hours, and a cashier task assigned to seven of those eight hours (e.g., with one hour of idle time). The shift record 304-6 has a total length of four hours, and a bagging task assigned to all four hours. The shift records 304 can also include location indicators (e.g., identifying a facility, or in some cases a portion of a facility). The shift records 304 can also include various other attributes, including employee identifiers that indicate which employee 104 is currently assigned to a shift. As seen in FIG. 3, the shift record 304-6 indicates that it is assigned to the employee 108-2. The shift record 304-4, however, has a null employee identifier, and is therefore an open shift.

The device 120 can be configured, whether automatically or in response to a command from the administrator 112, to transmit a notification 308 to one or more of the client devices 108. The notification 308 is a request for allocation requests, or bids, to accept the open shift defined by the shift record 304-4. For example, in FIG. 3 the notification 308 is transmitted to each of the client devices 108-1, 108-2, and 108-3, as the corresponding employees 104 are eligible for the shift record 304-4 and available during the time defined by the shift record 304-4. The notification 308 contains at least a portion of the data in the shift record 304-4, and may also include an incentive value (e.g., a monetary incentive or the like). The notification 308 can be presented at each client device 108, and each employee 104 can determine whether or not to bid for the shift record 304-4. A negative reply, or a lack of reply, from a client device 108 indicates to the device 120 that the corresponding employee 104 does not wish to accept the open shift from the notification 308. A positive reply 312, e.g., as shown being transmitted by the device 108-3, indicates that the employee 104-3 does wish to accept the shift record 304-4. The reply 312, in other words, can also be referred to as an allocation request. As will be apparent, in some cases the device 120 may receive multiple allocation requests 312 in response to a single notification 308, e.g., if more than one employee 104 wishes to accept an open shift.

The performance of block 205 includes collecting a plurality of allocation requests as described above. For example, the device 120 can retrieve, e.g., from the repository 156, allocation requests corresponding to previous unallocated shifts over a predetermined time period (e.g., one month, although shorter or longer periods can also be contemplated).

At block 210, the device 120 is configured to label each previous unallocated shift based on the allocation requests retrieved at block 205. Labelling the unallocated shifts permits the device 120 to autonomously generate a training data set. The training data set can then be used, as discussed below, to generate a classifier. The device 120 is configured to label the previous unallocated shifts based on a quantified level of interest in each unallocated shift from the employees 104. Each unallocated shift can be assigned a label selected from a predetermined range, e.g., based on a number of allocation requests received at the device 120 for that unallocated shift. In some examples, the label is selected based on a statistical distribution of the allocation requests, rather than on an absolute number of allocation requests.

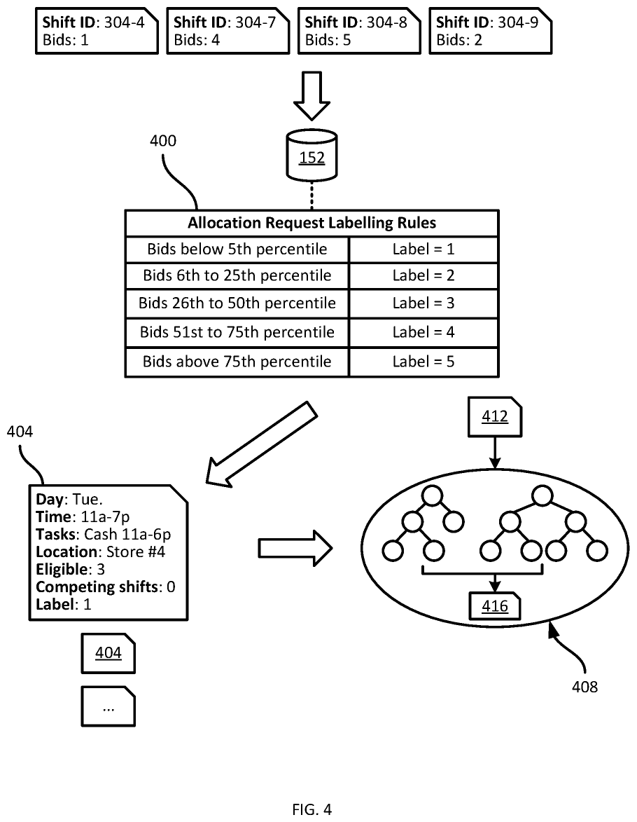

Turning to FIG. 4, an example labelling process implemented by the device 120 at block 210 is illustrated. The device 120 can, for example, determine a count of allocation requests received for each previously unallocated shift. Four example unallocated shifts 304-4, 304-7, 304-8, and 304-9 are shown, with corresponding bid counts of one, four, five, and two. The device 120 can collect other numbers of unallocated shifts than the four shown in FIG. 4, and the bid counts may also vary widely from the examples shown in FIG. 4.

The device 120 is then configured to determine a statistical distribution of the bid counts, e.g., by determining standard deviations, percentiles or other suitable intervals within the range of bid counts received for the previous unallocated shifts. The repository 152 can include labelling criteria 400, such as the example labelling criteria 400 shown in FIG. 4, which defines labels between “1” and “5” for each previous unallocated shift 304, based on the position of the bid count for that unallocated shift within the statistical distribution of all previous unallocated shifts. The label “1” corresponds to a less popular unallocated shift, indicated by the relatively small number of allocation requests received for that shift. The label “5” corresponds to a more popular unallocated shift. The example intervals shown in FIG. 4 (e.g., a label of “3” if the bid count for an unallocated shift falls between the twenty-sixth and fiftieth percentile) are for illustrative purposes only. In other implementations, a different range of labels than the range of 1-5 shown in FIG. 4 can be employed, and different intervals for each value in the label range can also be employed.

Based on the label criteria, the device 120 is configured to generate a training data sample for each unallocated shift 304. For example, the device 120 can generate a training sample 404 corresponding to the unallocated shift 304-4. The training sample 404 includes at least a portion of the data defining the shift 304-4 (e.g., the weekday, shift time, tasks, and the like). The training sample 404 can also include additional values derived from the allocation requests corresponding to the shift 304-4. For example, as illustrated in FIG. 4, the training sample 404 includes an “Eligible” value indicating the number of employees 104 eligible to request the shift 304-4. The number of eligible employees 104 can be determined based on data in the repository 152, e.g., based on whether other employees 104 are already assigned to a conflicting shift, are on vacation or otherwise unavailable at the time of the shift 304-4, have skills, certifications, or other attributes involved in performing tasks associated with the shift 304-4, and the like.

The training sample 404 can also include a number of competing shifts, indicating the number of other unallocated shifts that were available for filling at the time the shift 304-4 was advertised (whether or not those other shifts overlapped in time with the shift 304-4). The training sample 404 can also include values for other attributes, derived from the allocation requests. For example, the training sample 404 can include (not shown) an indication of an amount of time between advertisement of the shift 304-4 for bids, and the actual start time of the shift 304-4 (e.g., because reduced advertisement time may lower the number of bids received, independently of popularity or desirability of the shift 304-4). The training sample 404 can also include indicators of whether an unallocated shift is an opening or closing shift, occurs on a statutory holiday, or the like. Further the training sample 404 includes a label determined according to the criteria 400.

Referring again to FIG. 2, at block 215 the device 120 is configured to generate and/or train at least one classification model, also referred to below as a classifier 408, using the training samples 404 derived from labelled unallocated shift records. Various mechanisms can be employed to generate and/or train the classifier 408 using the training samples 404. In this example, the classifier 408 is a random forest classifier. The device 120 is configured to generate a plurality of decision trees based on randomly selected training samples 404, as well as randomly selected subsets of the variables within the training samples 404. Generating the decision trees is also based on hyperparameters such as a number of trees, a maximum trec depth, and the like. Generating the classifier 408 can include tuning the above hyperparameters and regenerating the decision trees based on the tuned hyperparameters, as will be apparent to those skilled in the art.

The classifier 408 is configured to accept as an input a new unallocated shift record 412, and to generate as an output a predicted index 416 (e.g., corresponding to an average of the output of each decision tree) of desirability or popularity for that unallocated shift record 412.

Through the performance of blocks 205, 210, and 215, the device 120 overcomes certain technical limitations of previous systems, by processing allocation requests and unallocated shifts to infer the desirability of unallocated shifts to employees 104. The inference of shift desirability, if performed at all in other systems, is reliant on subjective (and therefore error-prone and poorly scalable) judgements, e.g., by the administrator 112. The implementation of blocks 205-215 by the device 120 thus permits the device 120 to perform new functionality previously not performed by computing devices in scheduling systems.

Returning to FIG. 2, at block 220 the device 120 can be configured to detect an unallocated shift. For example, the device 120 can detect a change to the schedule 300 or another schedule, e.g., the addition of a shift without an assigned employee 104, or the removal of an employee identifier from a previously assigned shift. In response to detecting an unallocated shift, the device 120 proceeds to block 225. In some examples, the device 120 can proceed to block 225 in response to detecting a single open shift at block 220, e.g., substantially immediately upon such detection. In other examples, the device 120 can perform block 225 in response to a threshold number of detections at block 220 (e.g., when five or more open shifts have been detected, and/or when a threshold period of time has elapsed since the detection of the first open shift).

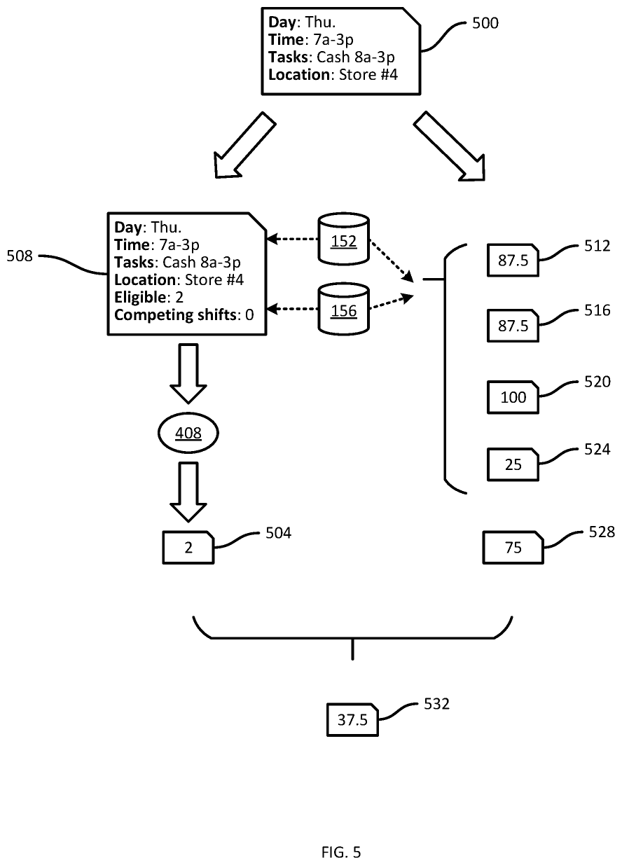

At block 225, the device 120 is configured to obtain an index for the unallocated shift detected at block 220, via the classifier 408. The device 120 is configured, as discussed below in connection with FIG. 5, to generate an input record, e.g., a feature set represented as a vector or the like, based on the unallocated shift detected at block 220. The device 120 is configured to execute the classifier 408 to process the input record, and obtain an index indicating the predicted desirability of the unallocated shift. The index represents an expected level of interest employees 104 will have in claiming the unallocated shift.

At block 230, the device 120 is configured to generate an impact indicator corresponding to the unallocated shift from block 220. The impact indicator can be generated at least in part based on the index from block 225. The impact indicator is also generated based on a set of other attributes of the unallocated shift itself, the facility to which the unallocated shift corresponds, or both.

Turning to FIG. 5, an example performance of blocks 225 and 230 is illustrated. Having detected an unallocated shift 500, the device 120 is configured, at block 225, to obtain an index 504 for the shift 500 by generating an input record 508, e.g., extracting attributes from the unallocated shift record 500 and appending other attributes based on data in the repositories 152 and/or 156. For example, a number of employees 104 eligible to bid for the shift 500 can be determined based on records of employee vacations, preconfigured working days, eligibility for the shift 500, and the like. As a further example, the device 120 can determine a number of competing unallocated shifts, e.g., by determining how many (if any) other open shifts exist in an active schedule from the repository 156. The input record 508 is provided to the classifier 408, to generate the index 504. In the present example, the range of values employed for indices is between one and five, and the index 504 has a value of two, indicating that the shift 500 is predicted to be moderately unpopular.

The device 120 is also configured, e.g., in parallel with the performance of block 225, to determine at least one impact indicator component. The impact indicator components can include, for example, a task priority component 512 expressed as a proportion of the shift that is covered by high-priority tasks. The device 120 can retrieve task priorities (e.g., for the cashier task, in this example) from the repository 152. If the cashier task has a “high” priority (or any other suitable value indicating high priority), the device 120 can determine the component 512 as a ratio of the time covered by the cashier task to the total length of the shift 500. The ratio can therefore be, for example, seven hours of the eight-hour length of the shift 500, and/or twenty-eight of a total thirty-two 15-minute intervals, or 0.875. The component 512 can be expressed as a percentage, as shown in FIG. 5. If the cashier task has a priority other than “high”, the component 512 may have a value of zero. As will be apparent to those skilled in the art, however, a wide variety of other mechanisms can be employed to generate the component 512, as well as the other example components discussed below. These example components can also be modified by weighting factors (e.g., values between zero and one, with the sum of all weights being one).

In other examples, the device 120 can determine the component 512 as two subcomponents, e.g., one ratio based on the length of the shift 500, and a second ratio based on the maximum allowable shift length. The component 512 can be a weighted average of those sub-components. A similar sub-component mechanism can also be employed for other components, e.g., to account for the reduced impact of shorter shifts.

A further example component includes a task coverage component 516, e.g., expressed as a ratio of the time during the shift 500 that is covered by tasks (e.g., seven of eight hours in this example, or twenty-eight of thirty-two quarter-hour intervals). Another example component includes a opening or closing-shift component 520. The device 120 may, for example, determine based on facility attributes in the repository 152 when the facility opens and closes, and determine whether the shift 500 contains the facility opening or closing time. When such a determination is affirmative, the component 520 has a value of one hundred. Otherwise, the component 520 has a value of zero.

A further example component includes a minimum coverage component 524. For example, the device 120 can determine, e.g., from the repository 152, a minimum labor demand for the facility during the shift 500, as well as an amount of the labor demand that is unmet in the absence of the shift 500. For example, the minimum labor demand may indicate a number of employees expected on duty for each 15-minute period of each day. The device 120 can determine how many 15-minute periods exist during the shift 500 for which too few employees are currently scheduled. In the example of FIG. 5, there are eight such periods, covering one quarter of the shift 500. Other components can also be employed, e.g., including a peak intraday demand component, based on a portion of a reference period (indicating peak demand on the relevant weekday) that is covered by the unallocated shift 500.

The components 512, 516, 520, and 524 can be combined, e.g., by averaging (with configurable weights for each component in some examples), to generate an intermediate impact indicator 528, which in the present example has a value of seventy-five (in a range between zero and one hundred; various other ranges can also be employed in other examples). The device 120 is then configured to combine the intermediate impact indicator 528 with the index 504 to generate an impact indicator 532. In this example, the device 120 can be configured to divide the intermediate impact indicator 528 by the index 504 (the index 504 may also be weighted in some examples). As will be understood, higher indices, indicating higher desirability, may therefore reduce the impact indicator 532, while lower indices, indicating lower desirability, may increase the impact indicator 532. The adjustment of the intermediate impact indicator 528 with the index 504 reflects the potential case or difficulty of filling an open shift, which can mitigate or accentuate the impact associated with an open shift.

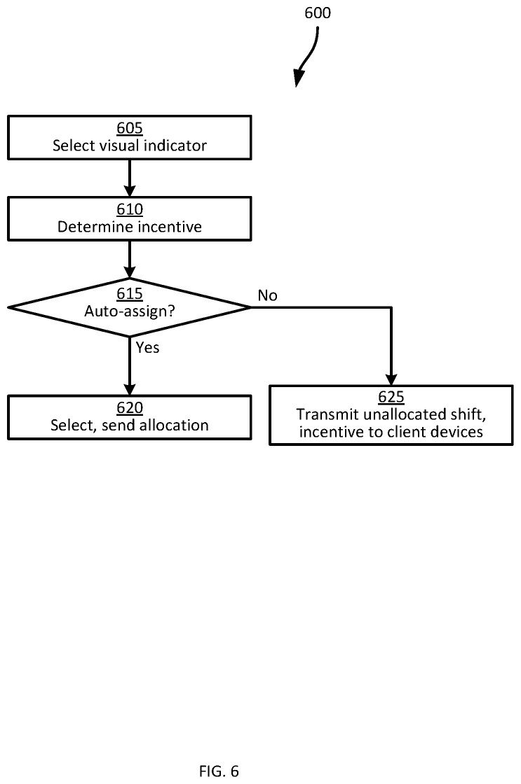

Returning to FIG. 2, at block 235 the device 120 is configured to select and execute one or more scheduling control actions based on the impact indicator from block 230. The control actions can include automatically assigning the unallocated shift 500 under certain conditions, presenting the unallocated shift 500 with certain visual indicators, and the like. FIG. 6 illustrates an example method 600 of performing block 235. For example, at block 605, the device 120 can select a visual identifier for the shift 500 based on the impact indicator 532, and present a schedule with the shift 500 associated with the visual indicator.

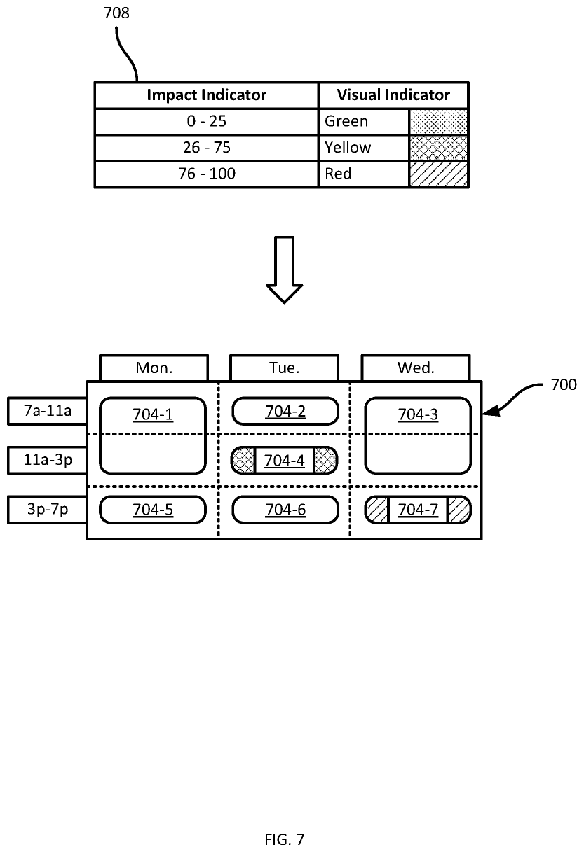

For example, as shown in FIG. 7, a schedule 700 including a plurality of shifts 704-1, 704-2, 704-3, 704-4, 704-5, 704-6, and 704-7 is illustrated. The shifts 704-4 and 704-7 are unallocated. Via a performance of the method 200, the device 120 can determine impact indicators for the shifts 704-4 and 704-7, and select visual indicators, e.g., from criteria 708, according to the impact indicators. The device 120 can then be configured to present the schedule 700 with the shifts 704-4 and 704-7 associated with the corresponding visual indicators, e.g., to draw attention to unallocated shifts likely to have a greater impact on the operations of the facility.

Returning to FIG. 6, at block 610 the device 120 can, instead of or in addition to selecting the visual indicators as discussed above, determine an incentive for an unallocated shift according to the impact indicator. For example, the device 120 can select a monetary incentive that is scaled between predetermined boundary values based on the impact indicator (e.g., by using the upper boundary value for an impact indicator of one hundred).

At block 615, the device 120 can determine whether to automatically assign an unallocated shift, for example by comparing the impact indicator to a threshold. The determination at block 615 can be affirmative if the impact indicator exceeds the threshold, and negative otherwise. When the determination at block 615 is affirmative, at block 620, the device 120 can select an employee 104 to assign to the unallocated shift, e.g., based on employee profile data in the repository 152, and transmit the assignment to the corresponding client device 108. In some examples, automatic assignment can include re-assigning an employee 104 from another shift to the unallocated shift. The device 120 can be configured, for example, to generate impact indicators 532 for filled shifts at block 620, and re-assign an employee 104 from a lower-impact shift to the unallocated shift. As will now be apparent, the newly unallocated shift resulting from re-assignment may then be processed via the method 200. When the determination at block 615 is negative, at block 625 the device 120 can be configured to transmit the unallocated shift, e.g., along with an incentive determined at block 610, to one or more client devices 108.

As will be apparent from the discussion above, the processing of shift data to generate the impact indicator, and the selection and execution of control actions based on the impact indicator, permits the device 120 to resolve certain technical limitations of previous systems. For example, the device 120 is enabled to perform functionality that, if performed at all in previous systems, was dependent on human judgement. The device 120 therefore implements functionality not previously implemented by computing devices, and in doing so may improve the efficiency with which resources are deployed in a facility, and/or the computational efficiency of generating and updating schedules. For example, the automated impact assessment of open shifts described above may reduce the likelihood of repeated edits and/or generations of scheduling data resulting from untimely or inaccurate subjective assessments of open shift impacts.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
detecting, at a computing device, an unallocated shift record corresponding to a facility, the unallocated shift record defining a time period and a task identifier;
executing, at the computing device, a classification model to generate an index corresponding to the unallocated shift record;
generating, at the computing device, an impact indicator for the unallocated shift record based on the time period, the task identifier, and the index;
selecting a control action for the unallocated shift record according to the impact indicator; and
executing the selected control action.

2. The method of claim 1, further comprising, prior to executing the classification model:
receiving, at the computing device, allocation requests for a plurality of previous unallocated shifts;
for each previous unallocated shift, determining a label based on a number of the allocation requests that correspond to the previous unallocated shift;
generating the classification model based on (i) the labels and (ii) the previous unallocated shifts.

3. The method of claim 2, wherein generating the classification model includes:
generating a random forest classification model configured to output a label for an unallocated shift record.

4. The method of claim 1, wherein generating the impact indicator includes:
retrieving a task priority corresponding to the task identifier; and
generating a component of the impact indicator based on the task priority.

5. The method of claim 4, wherein the unallocated shift record includes a portion of the time period corresponding to the task identifier; and
wherein generating the component of the impact indicator is further based on the portion of the time period.

6. The method of claim 1, wherein generating the impact indicator includes:
retrieving a reference time period, and generating a component of the impact indicator based on an overlap between the time period and the reference time period.

7. The method of claim 1, wherein selecting the control action includes:
(i) maintaining, at the computing device, a plurality of visual indicators associated with respective thresholds;
(ii) selecting one of the visual indicators by comparing the impact indicator to the thresholds; and
wherein executing the selected control action includes: controlling a display to present the unallocated shift record in association with the selected one of the visual indicators.

8. The method of claim 1, wherein selecting the control action includes:
determining, at the computing device, an incentive value based on the impact indicator; and
transmitting the unallocated shift record and the incentive value to a plurality of client devices.

9. A computing device, comprising:
a memory; and
a processor configured to:
detect an unallocated shift record corresponding to a facility, the unallocated shift record defining a time period and a task identifier;
execute a classification model to generate an index corresponding to the unallocated shift record;
generate an impact indicator for the unallocated shift record based on the time period, the task identifier, and the index;
select a control action for the unallocated shift record according to the impact indicator; and
execute the selected control action.

10. The computing device of claim 9, wherein the processor is further configured, prior to executing the classification model, to:
receive, at the computing device, allocation requests for a plurality of previous unallocated shifts;
for each previous unallocated shift, determine a label based on a number of the allocation requests that correspond to the previous unallocated shift;
generate the classification model based on (i) the labels and (ii) the previous unallocated shifts.

11. The computing device of claim 10, wherein the processor is configured to generate the classification model by:
generating a random forest classification model configured to output a label for an unallocated shift record.

12. The computing device of claim 9, wherein the processor is configured to generate the impact indicator by:
retrieving a task priority corresponding to the task identifier; and
generating a component of the impact indicator based on the task priority.

13. The computing device of claim 12, wherein the unallocated shift record includes a portion of the time period corresponding to the task identifier; and
wherein the processor is configured to generate the component of the impact indicator based on the portion of the time period.

14. The computing device of claim 9, wherein the processor is configured to generate the impact indicator by:
retrieving a reference time period, and generating a component of the impact indicator based on an overlap between the time period and the reference time period.

15. The computing device of claim 9, wherein the processor is configured to select the control action by:
(i) maintaining a plurality of visual indicators associated with respective thresholds;
(ii) selecting one of the visual indicators by comparing the impact indicator to the thresholds; and
wherein the processor is configured to execute the selected control action by:
controlling a display to present the unallocated shift record in association with the selected one of the visual indicators.

16. The computing device of claim 9, wherein the processor is configured to select the control action by:
determining an incentive value based on the impact indicator; and
transmitting the unallocated shift record and the incentive value to a plurality of client devices.
